(19) United States
(12) Patent Application Publication
(10) Pub. No.: US 2026/0274020 A1
(43) Pub. Date: Sep. 17, 2026

(54) Work Machine System with Tractor Unit and Interchangeable Trailer Units

(71) Applicant: Caterpillar SAR, Geneva (CH)

(72) Inventors: Stephen HERD, Durham (GB); Ashwin RAVEENDRAN, Chennai (IN); Mark STOKER, County Durham (GB); Mathankumar GUNASEKARAN, Chennai (IN)

(73) Assignee: Caterpillar SAR, Geneva (CH)

(21) Appl. No.: 18/868,641

(22) PCT Filed: May 19, 2023
(86) PCT No.: PCT/EP2023/025234

§ 371 Date: Nov. 22, 2024

(30) Foreign Application Priority Data
May 27, 2022 (GB) 2207869.5

(51) Int. Cl. B60D 1/64; B60D 1/00; B60D 1/04; B60D 1/50; B60P 1/04; B62D 12/00; B62D 53/02

(52) U.S. Cl. CPC B60D 1/64; B60D 1/04; B60D 1/50; B62D 12/00; B60D 2001/001; B60P 1/04; B62D 53/02

(57) ABSTRACT

A work machine system comprising a tractor unit releasably connectable to interchangeable trailer units by a coupling. When a trailer unit is coupled to the tractor unit a fully integrated work machine is formed for performing work functions. The work machine system can perform different work functions with only one tractor unit by connecting different trailer units capable of performing the different work functions to the tractor unit. The tractor and/or trailer units comprise a steering system for steering the work machine by controlling pivoting about an articulation joint.

### TECHNICAL FIELD

This disclosure is directed towards a work machine system with tractor unit and interchangeable trailer units. This disclosure is also directed towards a tractor unit, a plurality of trailer units and a method of operating the work machine system including changing the trailer unit attached to a tractor unit.

### BACKGROUND

Machines, such as articulated machines and/or off-highway vehicles including articulated trucks, scrapers (such as wheel tractor scrapers) and mining trucks (particularly underground mining trucks), commonly comprise a tractor unit connected to a trailer unit. These machines comprise one or more articulated joints allowing for articulation between the tractor and trailer units (e.g. for steering) and/or oscillation between the tractor and trailer units (e.g. as the tractor and trailer units independently roll at different angles as they move over a rough terrain). Commonly, the tractor comprises either a single axle or only two ground engaging components, wheels or the like, and as such, is stabilized by the articulated connection with the trailer.

The tractor and trailer units are permanently coupled to each another about the joint and are fully integrated with one another so that the machine is purposively designed to perform a certain range of tasks. As a result, for example, the units of an articulated truck may be designed to receive material from an excavator and transport such material in an open worksite, the units of a mining truck may be designed to transport material in an underground mine and the units of a wheel tractor scraper may be designed to collect material itself and transport the material around a worksite. Yet furthermore, the tractor and trailer units of articulated trucks may be designed for specific uses, such as by having a dump body or ejector body, for carrying containers, water, cable reels or fuel, for operating as a hooklift or by having high-capacity bodies for coal or waste and so on.

Worksites therefore often require a number of different work machines to suit different applications. Whilst such an approach ensures that an appropriate and efficient machine for a certain task is selected, it can mean that some types of machines remain idle on a worksite when they are not required, meaning they have a low rate of utilisation. In addition, it is often complex, time intensive and costly to design and manufacture a dedicated machine, including both its tractor and trailer unit, in order to fulfil a specific user requirement.

### SUMMARY

The present disclosure provides a work machine system, tractor unit, plurality of trailer units and method in accordance with the claims.

The present disclosure is generally directed towards a work machine system comprising a tractor unit releasably connectable to interchangeable trailer units by a coupling. When a trailer unit is coupled to the tractor unit a fully integrated work machine is formed for performing work functions. The work machine system can perform different work functions with only one tractor unit by connecting different trailer units capable of performing the different work functions to the tractor unit. The tractor and/or trailer units comprise a steering system for steering the work machine by controlling pivoting about an articulation joint. The forward direction of the machine, in which it operates the majority of the time, is with the trailer unit behind the tractor unit.

A tractor-trailer services connection may be aligned by the coupling of the tractor-trailer coupling such that it can be connected for exchanging electrical power, control signals and/or fluid (pneumatic and/or hydraulic) between the tractor unit and trailer unit. The tractor unit may comprise only two wheels (i.e. on a single axle and/or on separate axles rotating around a single tractor rotational axis) and no other ground engagers in contact with the ground when the work machine travels over the ground.

The work machine system of the present disclosure takes advantage of the similarities between certain types of work machines by having a unified tractor unit whilst enabling a plurality of different work functions to be performed with just one tractor unit by the trailer units being releasably couplable to the tractor unit. Development of new trailer units dedicated to a certain work functions can be achieved at lower cost and faster speeds because it is not necessary to design a tractor unit as well. Furthermore, such dedicated trailer units will be available at a lower cost (as compared to being permanently fixed to a tractor unit), meaning that more operators will be able to obtain trailer units for their specific requirements.

The work machine system comprises a tractor unit comprising a tractor coupling and at least one tractor ground engager, which may be wheels or tracks. The at least one tractor ground engager is driven by a tractor power system. The system also comprises interchangeable trailer units each having at least one ground engager, such as wheels or tracks, and a trailer coupling that is releasably coupleable to the tractor coupling of the tractor unit. A work machine is therefore formed by the coupled tractor and trailer units. The tractor and/or trailer units comprise a steering system for controlling pivoting about the articulation joint for steering the work.

The tractor unit comprises a tractor coupling for releasably coupling to a trailer coupling of a plurality of interchangeable trailer units. At least one tractor ground engager, such as tracks or wheels, is driven by a tractor power system. The tractor coupling, at least one tractor ground engager and tractor power system are mounted to a tractor frame. An articulation joint is mounted to the tractor frame. The tractor coupling is mounted to the articulation joint and is configured to pivot about the articulation joint relative to the tractor frame. A steering system, which may be mounted to the tractor frame, is for controlling the pivoting of the trailer coupling relative to the tractor frame for, when the tractor unit is coupled to a trailer unit, steering the tractor unit relative to the trailer unit about the articulation joint.

Each trailer unit of the plurality of trailer units comprises a different at least one haul body or tool to the other trailer units for performing different work functions. At least one trailer ground engager is for supporting the trailer unit on the ground. Trailer couplings of the trailer units are independently releasably coupleable to a tractor coupling of a tractor unit to form a work machine.

The method of operating the work machine system comprises operating a first work machine comprising a tractor unit coupled to a first trailer unit to perform a first work function. The tractor unit is releasably coupleable to the trailer units and comprises at least one tractor ground engager, such as wheels or tracks, driven by a tractor power system. The tractor unit is subsequently uncoupled from the first trailer unit by uncoupling a tractor coupling of the tractor unit from a trailer coupling of the first trailer unit. The tractor unit is aligned with a second trailer unit and they are coupled together by coupling the tractor coupling with a trailer coupling of the second trailer unit. A second work machine is thereby formed, which is operated to perform a second work function different to the first work function.

The present disclosure also provides a tractor unit for the aforementioned work machine system, the tractor unit comprising the tractor coupling for releasably coupling to a trailer coupling of a plurality of interchangeable trailer units and the at least one tractor ground engager driven by the tractor drive system, optionally wherein the tractor unit comprises the steering system for steering the work machine by controlling pivoting the articulation joint.

The present disclosure also provides a trailer unit for the aforementioned work machine system, the trailer unit comprising the at least one trailer ground engager and the trailer coupling for releasably coupling the trailer unit to the tractor coupling of the tractor unit, optionally wherein the trailer unit comprises an oscillation hitch for enabling oscillation of the tractor and trailer units relative to one another when the tractor and trailer couplings are coupled.

The present disclosure also provides a work machine comprising: a tractor unit comprising a tractor coupling and a tractor services connection; and a trailer unit comprising a trailer coupling and a trailer services connection; wherein the tractor and trailer couplings are releasably couplable together to mechanically couple the tractor and trailer units together and, when coupled, align the tractor and trailer services connections together such that the tractor and trailer services connections can be connected together for the exchange of electrical power, fluid and/or control signals between the tractor and trailer units.

### BRIEF DESCRIPTION OF THE DRAWINGS

By way of example only, embodiments of the present disclosure are now described with reference to, and as shown in, the accompanying drawings, in which:

FIG. 1 is a schematic perspective view of a work machine system in accordance with the present disclosure including a tractor unit and a plurality of interchangeable trailer units;

FIG. 2 is a side elevation of a work machine form from a tractor unit and one of the trailer units of the work machine system of FIG. 1;

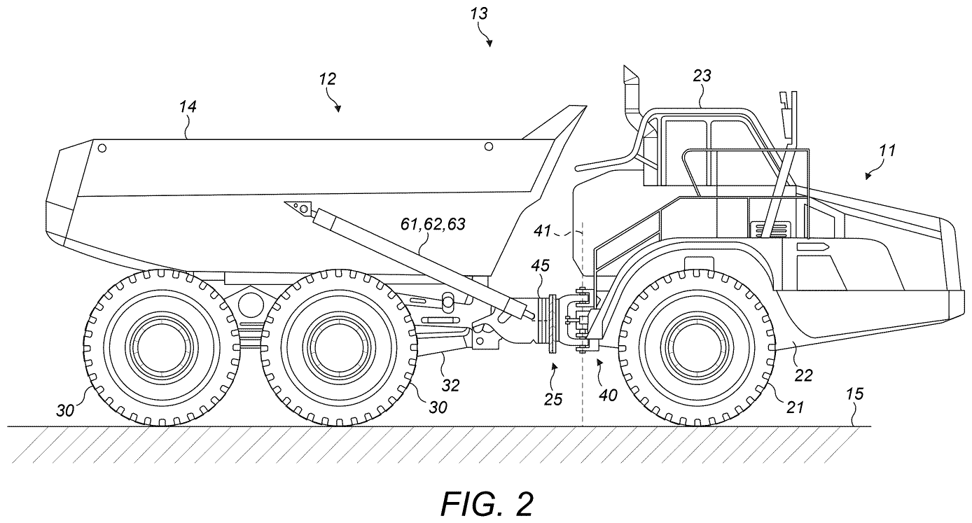

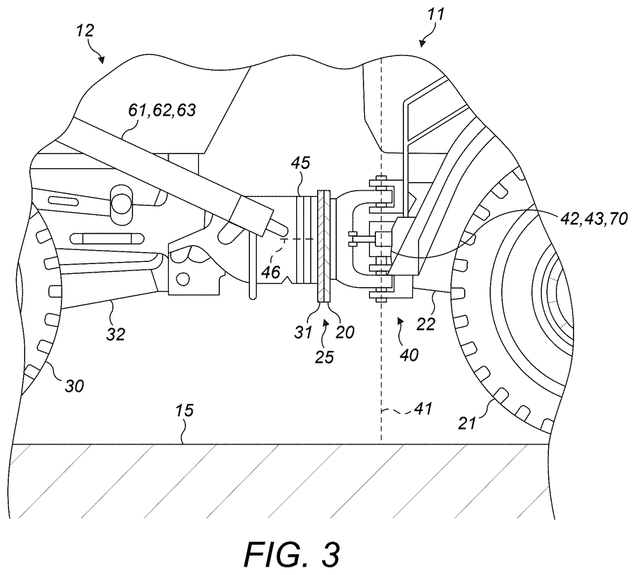

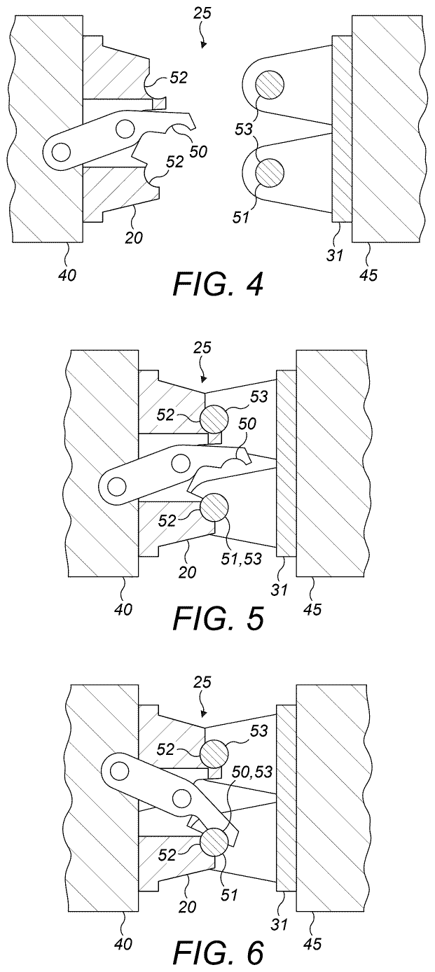

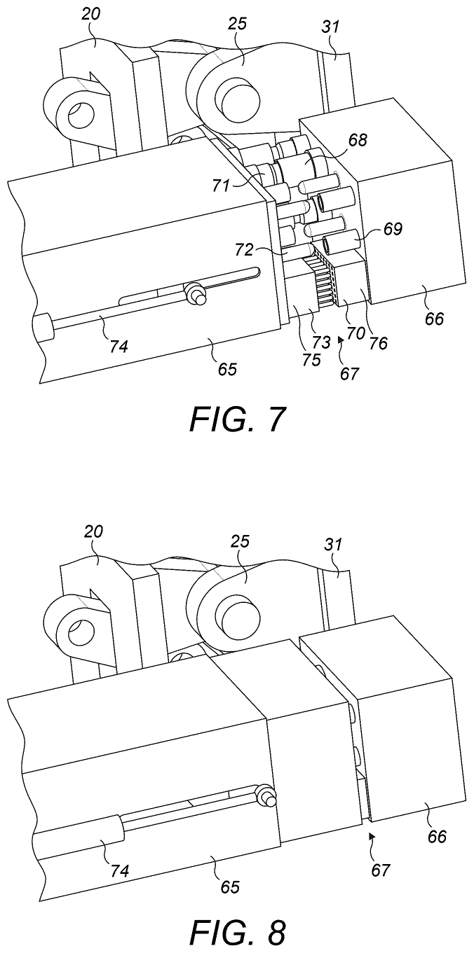

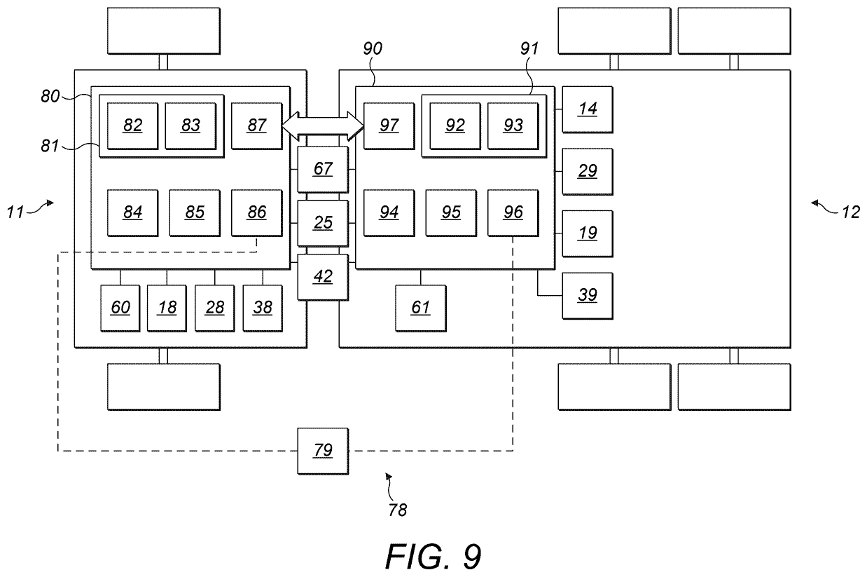

### FIG. 3 is a magnified view of a portion of FIG. 2 illustrating a tractor-trailer coupling of the work machine;

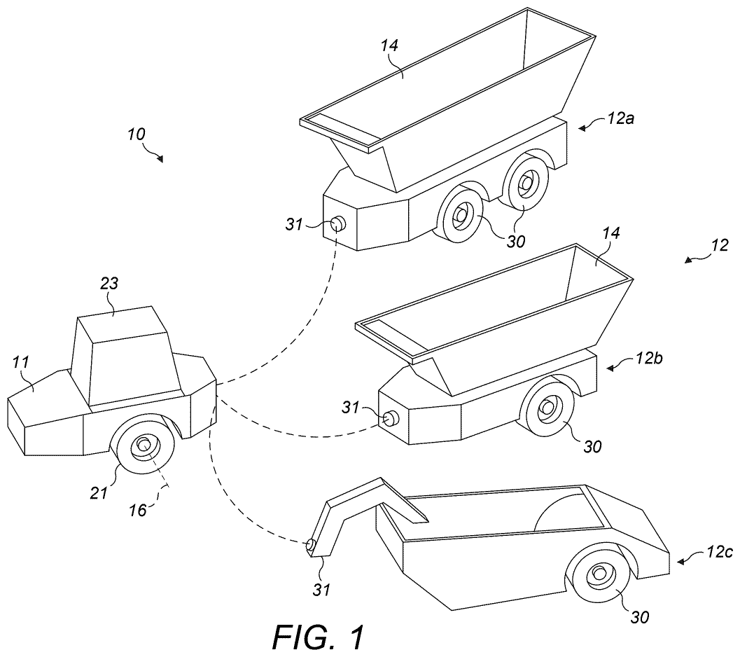

FIGS. 4 to 6 are cross-sectional views showing the coupling of an embodiment of a tractor-trailer coupling for the work machine system of FIG. 1;

FIGS. 7 and 8 are perspective views showing the tractor-trailer coupling of FIGS. 4 to 6 and a tractor-trailer services connection in the process of being connected; and

FIG. 9 is a schematic of a work machine control system for the work machine of the present disclosure.

### DETAILED DESCRIPTION

FIG. 1 schematically illustrates a work machine system 10 of the present disclosure comprising a tractor unit 11 and a plurality of interchangeable trailer units 12. The tractor unit 11 is coupleable to each of the trailer units 12 and a work machine 13, an example of which is illustrated in FIG. 2, is formed by the tractor unit 11 being coupled to one of the trailer units 12. The work machine 13 formed from the tractor unit 11 and one of the trailer units 12 may be configured for off-highway operation and/or the tractor and trailer units 11, 12 comprise off-highway wheels or tracks mounted to an off-highway suspension system. The work machine 13 may be an earth moving machine.

In general, each of the tractor and trailer units 11, 12 are not designed as standalone vehicles and serve no practical purpose in isolation. However, once coupled together, the tractor and trailer units 11, 12 together form a fully integrated work machine 13.

The tractor unit 11 comprises a tractor coupling 20 and at least one tractor ground engager 21 driven by a tractor drive system 18. The tractor unit 11 may alternatively be referred to as a drive unit and generally refers to the unit that provides the main driving power to the work machine 13. The tractor drive system 18 may comprise a power source, for example an internal combustion engine, a turbine, a fuel cell or a battery, for providing power to drive the at least one tractor ground engager 21, for example via a power train and/or motor. The tractor unit 11 may comprise a tractor electrical power system 38, which may comprise a battery and at least one electrical consumer, such as lights, operator controls and the like. If the tractor drive system 18 is electrical then the tractor electrical power system 38 may comprise the tractor drive system 18.

The at least one tractor ground engager 21 may be wheels as illustrated or may comprise tracks, a roller or the like. The at least one tractor ground engager 21 may rotate about a tractor rotational axis 16 and in particular may comprise a pair of wheels driven about the tractor rotational axis 16. The pair of wheels may be mounted to a single axle or may have motors mounted directly thereto.

The tractor unit 11 may comprise a tractor frame 22 (which may be the chassis and/or main body of the tractor unit 11) and may comprise a cab 23 for an operator. The cab 23 may be mounted to the tractor frame 22 and may comprise the operator controls for controlling the work machine 13. The tractor unit 11 may comprise a tractor braking system 28 for braking the tractor unit 11, such as by applying a braking force to the at least one tractor ground engager 21. The at least one tractor ground engager 21 (for example via a suspension system), cab 23, tractor drive system 18, tractor braking system 28, tractor electrical power system 38 and/or tractor coupling 20 may be mounted to the tractor frame 22.

The tractor unit 11 may not be independently moveable about the ground 15 by the tractor drive system 18 when the tractor unit 11 is not coupled to a trailer unit 12. The tractor unit 11 may comprise no further tractor ground engagers in contact with the ground 15 when the work machine 13 is driven across the ground 15, for example comprising only a pair of wheels rotating around the tractor rotational axis 16. The centre of mass of the tractor unit 11 may also be offset from the at least one tractor ground engager 21 and/or tractor rotational axis 16 such that the tractor unit 11 is unbalanced when not coupled to a trailer unit 12. The coupling between the tractor and trailer units 11, 12 may counterbalance rotation of the tractor unit 11 about the tractor rotational axis 16 due to the offset centre of mass.

The tractor unit 11 may comprise a tractor control system 80 for controlling the functions thereof. The tractor control system 80 may be connected to and control the tractor drive system 18, tractor electrical power system 38 and/or braking system 28.

Each trailer unit 12 comprises at least one trailer ground engager 30 and a trailer coupling 31, which may be mounted to a trailer frame 32 of the trailer unit 12 (which may be the chassis and/or main body of the trailer unit 12). The tractor and trailer couplings 20, 31 are couplable together and form a tractor-trailer coupling 25. Each trailer unit 12 may comprise a haul body or tool 14 for performing work functions. The trailer unit 12 may comprise a trailer braking system 29 for braking the trailer unit 11, such as by applying a braking force to the at least one trailer ground engager 30.

The trailer units 12 may each be different and may be configured for performing different work functions. For example, each trailer unit 12 may comprise a different at least one haul body or tool 14 comprising a dump body, scraper, ejector body, open container, container for water, fuel, lubricant or the like, cable reel, hooklift, high-capacity body for coal or waste, low profile body for underground mining, flat bed, cement mixer, forestry body, shipping container bed, pipe carrier and so on. For example, FIG. 1 illustrates a trailer unit 12a comprising a dump body 14, a trailer unit 12b comprising a low-profile body for underground mining and a trailer unit 12c for forming a wheel tractor scraper.

As a result, when each trailer unit 12 is coupled to the tractor unit 11 a different work machine 13 with different work functions is formed, such as an articulated truck, a mining truck (such as an underground mining truck) or a scraper (such as a wheel tractor scraper). For example, FIG. 2 illustrates a work machine 13 in the form of an articulated hauler formed by a trailer unit 12 with a dump body 14 being coupled to the tractor unit 11. Thus, the same tractor unit 11 can be used to form different work machines 13 and/or perform different work functions by coupling different trailer units 12 thereto.

The at least one trailer ground engager 30 may comprise at least one pair of wheels as illustrated or may comprise tracks, a roller or the like depending upon the work function of the trailer unit 12. The at least one trailer ground engager 30 may be mounted to the trailer frame 32 by a trailer suspension system.

At least one of the trailer units 12 may comprises a trailer drive system 19 connected to and for driving the at least one trailer ground engager 30. For example, the trailer drive system 19 may comprise a power transfer system for transferring power mechanically (via a power train) or electrically (via an electrical system and at least one motor) to the at least one trailer ground engager 30. The trailer unit 12 may comprise a trailer electrical power system 39, which may comprise a battery and at least one electrical consumer, such as lights, operator controls and the like.

The at least one trailer unit 12 with a trailer drive system 19 may not be independently moveable about the ground 15 by the trailer drive system 19 when the tractor unit 11 is not coupled to the at least one trailer unit 12. For example, the trailer drive system 19 may receive drive power from the tractor drive system 18 via the tractor and trailer couplings 20, 31, as discussed further below. Alternatively, the trailer drive system 19 may comprise an independent power source, such as a battery, fuel cell, internal combustion engine and/or turbine for driving the at least one trailer ground engager 30, such as via a power train or motor. If the trailer drive system 19 is electrical then the trailer electrical power system 39 may comprise the trailer drive system 19.

The trailer unit 12 may comprise a trailer control system 90 for controlling the functions thereof. The trailer control system 90 may be connected to and control the trailer drive system 19 and/or trailer braking system 29.

The work machine 13 is generally configured to operate in a forward direction for a majority of its operation with the trailer unit 12 behind the tractor unit 12. Therefore, the tractor 11 may be configured to pull the trailer unit 12 for a majority of its operating time. Whilst the work machine 13 may be able to reverse, travelling with the tractor unit 11 behind the trailer unit 12, the components thereof are designed and configured to operate at a maximum forward speed in the forward direction with the tractor unit 11 pulling the trailer unit 12. The maximum rated forward speed, with the trailer unit 12 behind the tractor unit 11, may be greater than the maximum rated reversing speed, with the tractor unit 11 behind the trailer unit 12.

The tractor and trailer units 11, 12 are pivotable at least partially relative to one another about an articulation joint 40, which may be along an articulation axis 41. The articulation joint 40 may allow pivoting of at least part of the tractor unit 11 relative to at least part of the trailer units 12 relative to one another in a horizontal plane substantially parallel to the ground 15. The articulation joint 40 may be of any suitable configuration, such as including a pin as illustrated.

Steering of the work machine 13 is achieved by a steering system 42 which controls pivoting about the articulation joint 40. The steering system 42 may be of any suitable configuration. In particular, as illustrated the steering system 42 may comprise at least one actuator 43, for example at least one hydraulic cylinder, extending across the articulation joint 40 and for controlling the pivoting about the articulation joint 40. The articulation joint 40 and/or steering system 42 may be mounted to a frame 22, 32 of the tractor and trailer units 11, 12. The steering system 42 may be controlled by the tractor and/or trailer control system 80, 90.

As illustrated in FIGS. 2 and 3, the tractor unit 11 may comprise the articulation joint 40 and steering system 42. The articulation joint 40 and steering system 42 may be located between the tractor coupling 20 and the tractor frame 22. Hence the tractor coupling 20 may be mounted on the other side of the articulation joint 40 to the tractor frame 22. The tractor coupling 20 may be pivotable about the articulation axis 41 relative to the tractor frame 22. As a result, in such an arrangement it is not necessary to have multiple articulation joints 40 or steering systems 42 on each trailer unit 12, thereby reducing redundancy.

Alternatively, and not shown in the Figures, the trailer unit 12 may comprise the articulation joint 40 and steering system 42. The articulation joint 40 and steering system 42 may be located between the trailer coupling 31 and the trailer frame 32. Hence the trailer coupling 31 may be mounted on the other side of the articulation joint 40 to the trailer frame 32. The trailer coupling 31 may be pivotable about the articulation axis 41 relative to the trailer frame 32. As a result of this arrangement the articulation joint 40 and steering system 42 can be designed to suit the specific work function of each trailer unit 12.

In a further embodiment both the tractor and trailer units 11, 12 may comprise separate articulation joints 40 and steering systems 42 on either side of the tractor-trailer coupling 25. Therefore, the versatility of the articulation and steering of the work machine 13 may be improved.

The tractor and/or trailer units 11, 12 may comprise an oscillation hitch 45 for enabling oscillation of the tractor and trailer units 11, 12 relative to one another when the tractor and trailer couplings 20, 31 are coupled. The oscillation hitch 45 may enable oscillation about an oscillation axis 46 such that the tractor and trailer units 11, 12 can roll relative to one another. The oscillation axis 46 may be orthogonal to the articulation axis 41 and the articulation and oscillation axes 41, 46 may extend in the same plane, which may be orthogonal to a plane parallel to the ground 15.

As illustrated in FIG. 3, the trailer unit 12 may comprise the oscillation hitch 45 and the oscillation hitch 45 may be mounted between the trailer coupling 31 and trailer frame 32 such that the trailer coupling 31 can oscillate relative to the trailer frame 32. Alternatively, the tractor unit 11 may comprise the oscillation hitch 45 and the oscillation hitch 45 may be mounted between the tractor coupling 20 and tractor frame 22 such that the tractor coupling 20 can oscillate relative to the tractor frame 22.

The oscillation hitch 45 may be on the opposing side of the tractor-trailer coupling 25 to the articulation joint 40 as illustrated in FIG. 3. Alternatively, the oscillation hitch 45 may be on tractor or trailer unit 11, 12 with the articulation joint 40, for example by being located between the articulation joint 40 and the tractor or trailer coupling 20, 31 respectively.

Rather than having an oscillation hitch 45, oscillation may be achieved through the suspension system of the tractor and/or trailer unit 11, 12.

The tractor and trailer couplings 20, 31 together form the tractor-trailer coupling 25 of the work machine 13 for mechanically connecting the tractor and trailer units 11, 12 together. The tractor-trailer coupling 25 may be the only part carrying the mechanical load between the tractor and trailer units 11, 12. The tractor-trailer coupling 25 may be configured to be coupled and uncoupled to change the trailer unit 12 attached to the tractor unit 11 by an operator on a worksite without external assistance. The tractor-trailer coupling 25 may or may not require any tools to couple and uncouple and is not permanent. Hence the tractor unit 11 and tractor coupling 20 are configured to be coupled and uncoupled from a plurality of trailer units 12 throughout their rated lifetime. The tractor-trailer coupling 25 may be a bolted flange requiring tools for coupling and uncoupling.

The tractor-trailer coupling 25 may be a quick disconnect coupler and may have any suitable arrangement allowing for the quick changing of a trailer unit 12. The tractor-trailer coupling 25 may comprise a fastener 50 for engaging with at least one mount body 51 for fastening the tractor and trailer couplings 20, 31 together. FIGS. 4 to 6 illustrate an exemplary tractor-trailer coupling 25 in accordance with the present disclosure comprising a fastener 50 comprising at least one hook 50 for hooking around at least one mount body 51. The tractor and trailer couplings 20, 31 may comprise the fastener 50 and at least one mount body 51 respectively as illustrated. Alternatively, the tractor and trailer couplings 20, 31 may comprise the at least one mount body 51 and fastener 50 respectively or the tractor and trailer couplings 20, 31 may both comprise mount bodies 51 and fasteners 50.

As illustrated, by the sequence of FIGS. 4 to 6, the fastener 50 may be operable to engager or hook around and hold the at least one mount body 51 to couple the tractor-trailer coupling 25 and thus connect the tractor and trailer units 11, 12 together. The fastener 50 may comprise or be mounted on a lever actuatable from an uncoupled position (FIGS. 4 and 5) to a coupled position (FIG. 6). The at least one mount body 51 may comprise at least one pin as illustrated.

The tractor-trailer coupling 25, such as the actuation of the fastener 50, may be controlled by the tractor and/or trailer control system 80, 90.

The tractor-trailer coupling 25 may also comprise first and second load bearing portions 52, 53 each on one of the tractor and trailer couplings 20, 31. The first and second load bearing portions 52, 53 may be configured to transfer the mechanical load through the tractor-trailer coupling 25 between the tractor and trailer units 11, 12 and thus may be sufficiently stiff and strong to meet the rated loading. The first and second load bearing portions 52, 53 may comprise at least one recess 52 into which at least one pin 53 may be mounted when the tractor and trailer couplings 20, 31 are coupled together as in FIG. 6.

The tractor unit 11 may comprise a tractor fluid system 60 for controlling hydraulic and/or pneumatic functions of the tractor unit 11, such as the steering system 42. The trailer unit 12 may comprise a trailer fluid system 61 for controlling hydraulic and/or pneumatic functions of the trailer unit 12, such as the steering system 42 and/or a cylinder 62 for raising and lowering a dump body 14. The tractor and/or trailer fluid system 60 may each comprise at least one pump for selectively directing fluid between a reservoir and at least one actuator 43, 62. The tractor and trailer fluid system 60, 61 may be controlled by the tractor and trailer control systems 80, 90 respectively.

The tractor unit 11 may comprise a tractor services connection 65 and each trailer unit 12 may comprise a trailer services connection 66 and the tractor services connection 65 may be coupleable to each trailer services connection 66 for the transfer of electrical power (e.g. high voltage power), fluid and/or control signals (e.g. low voltage control signals) between the tractor and trailer units 11, 12. The tractor and trailer services connection 65, 66 may together form a tractor-trailer services connection 67, an exemplary coupling sequence of which is illustrated in FIGS. 7 and 8.

FIGS. 7 and 8 do not show any other part of the work machine system 10 other than the tractor-trailer services connection 67 and the tractor-trailer coupling 25. As illustrated, the tractor-trailer services connection 67 and the tractor-trailer coupling 25 may be substantially adjacent to one another and may be located between the tractor and trailer units 11, 12. The tractor and trailer services connections 65, 66 may be mounted to the tractor and trailer frames 22, 32.

As illustrated in FIG. 7, the tractor services connection 65 may comprise at least one fluid port 68, at least one electrical port 69 and/or at least one control port 70 engageable with an opposing port 71, 72, 73 of the trailer services connection 66. The tractor and trailer services connections 65, 66 may each comprise a single block 75, 76 to which the ports 68, 69, 70, 71, 72, 73 are mounted as illustrated such that their connection occurs simultaneously. Alternatively, the tractor and trailer services connections 65, 66 may comprise a series of independently moveable blocks resulting in the ports 68, 69, 70, 71, 72, 73 being sequentially connected to one another.

The tractor and/or trailer services connection 65, 66 may be moveable relative to one another for connection therebetween. The tractor-trailer services connection 67 may comprise at least one services actuator 74 for moving the tractor and/or trailer services connection 65, 66 relative to one another so as to connect them together, such as by bringing the ports 68, 69, 70, 71, 72, 73 together. The at least one services actuator 74 may comprise at least one fluid cylinder as shown, which may be controlled by the tractor and/or trailer fluid system 60, 61.

The tractor-trailer services connection 67 may enable the transfer of electrical power, such as through the ports 68, 69, 70, 71, 72, 73 between the tractor and trailer electrical power systems 38, 39, the transfer of fluid (pneumatic and/or hydraulic) between the tractor and trailer fluid systems 60, 61 and/or the transfer of control signals between the tractor and trailer control systems 80, 90. Thus, when the tractor-trailer services connection 67 between the tractor unit 11 and one of the trailer units 12 is coupled, tractor and trailer electrical power systems 38, 39 may form an integrated work machine electrical power system, the tractor and trailer fluid systems 60, 61 may form an integrated work machine fluid system 63 and/or the tractor and trailer control systems 80, 90 may form an integrated work machine control system 78. Thus the tractor unit 11 may be able to control the trailer unit 12 and vice-versa.

The tractor and trailer couplings 20, 31 may mechanically connect the tractor and trailer units 11, 12 for allowing the transfer of load between them. The coupling of the tractor and trailer couplings 20, 31 may bring the tractor and trailer services connections 65, 66 into alignment with one another for connection together. Thus the fully integrated work machine electrical power, fluid and control systems 63, 78 may be formed.

The tractor and trailer drive systems 18, 19 may be rotationally and/or torsionally connected to one another, such as via a clutch, sliding spline or bolted flange or the like, by the coupling of the tractor and trailer couplings 20, 31. In particular, a mechanical powertrain may be connected upon coupling of the tractor and trailer couplings 20, 31 such that power can be shared mechanically across the tractor-trailer coupling 25. Alternatively, the tractor and trailer drive systems 18, 19 may be electrically connected to on another across the tractor-trailer services connection 67, particularly if they form part of the tractor and trailer electrical power systems 38, 39.

In the work machine electrical power system, electrical power may be transferred between the tractor and trailer electrical power systems 38, 39 such that, for example, electrical power from batteries in the tractor and trailer electrical power systems 38, 39 may be shared with electrical consumers in the trailer and tractor electrical power systems 38, 39 respectively. In the work machine fluid system 63, pressurised fluid may be shared between the tractor and trailer fluid systems 60, 61 such that fluid actuators in either of the tractor and trailer units 11, 12 may be controlled by pumps in either of the tractor and trailer units 11, 12. In particular, the work machine fluid system 63 may enable the control of fluid actuators in the trailer unit 12 by at least one pump in the tractor unit 11.

The tractor and trailer couplings 20, 31 and/or tractor and trailer services connections 65, 66 may comprise at least one magnetic alignment system for bringing them into alignment and/or contact with one another for coupling or connection together. The magnetic alignment system may be located at or adjacent to at least one of the tractor and trailer couplings 20, 31 and/or tractor and trailer services connections 65, 66. Once the tractor and trailer couplings 20, 31 and/or tractor and trailer services connections 65, 66 have been brought into close proximity to one another, the at least one magnetic alignment system may draw them together into their connected positions. Therefore, only rough alignment is initially required, with full alignment being achieved via the at least one magnetic alignment system.

The work machine control system 78 is illustrated further in FIG. 9. The tractor and/or trailer control systems 80, 90 may each comprise a tractor and/or trailer controller 81, 91, for controlling the various parts of the tractor and trailer units 11, 12 respectively. The tractor and/or trailer controller 81, 91 may be of any suitable known type and may comprise an engine control unit (ECU) or the like. The tractor and/or trailer controller 81, 91 may comprise multiple control units, such as an ECU, auxiliary ECU(s) or control unit(s), artificial intelligence control unit(s) and the like. Generally, the tractor and/or trailer controller 81, 91 may comprise a tractor and/or trailer memory 82, 92 (e.g. multiple memories on different control units), which may store instructions or algorithms in the form of data, and a tractor and/or trailer processing unit 83, 93 (e.g. multiple processing units on different control units), which may be configured to perform operations based upon the instructions. The tractor and/or trailer memory 82, 92 may comprise one or more suitable computer-accessible or non-transitory storage mediums for storing computer program instructions, such as RAM, SDRAM, DDR SDRAM, RDRAM, SRAM, ROM, magnetic media, optical media and the like. The tractor and/or trailer processing unit 83, 93 may comprise one or more suitable processors capable of executing memory-stored instructions, such as a microprocessor, uniprocessor, a multiprocessor and the like. The tractor and/or trailer controller 81, 91 may further comprise one or more graphics processing units (e.g. multiple graphics processing units on different control units) for rendering objects for viewing on a tractor and/or trailer display 84, 94, which may only be present on the tractor unit 11 such as in the cab 23, and any other computing system equipment required for performing the functions of the tractor unit 11 and trailer unit 12.

The tractor controller 81 may be communicatively connected (via a wired or wireless connection), to receive inputs from and/or exchange data with, at least one tractor operator input 85, which may be in the cab 23. The trailer controller 91 may be communicatively connected (via a wired or wireless connection), to receive inputs from and/or exchange data with, at least one trailer operator input 95, which may be on a control panel of the trailer unit 12.

The tractor and/or trailer control systems 80, 90 may each comprise a tractor and/or trailer external communication system 86, 96 for transferring data between the control system(s) 80, 90 and a remote computer system 79. The tractor and/or trailer external communication system(s) 86, 96 may comprise any type of suitable apparatus for communication therebetween, particularly a wireless network. Exemplary wireless networks include a satellite communication network, broadband communication network, cellular, Bluetooth, microwave, point-to-point wireless, point-to-multipoint wireless, multipoint-to-multipoint wireless, Wireless Local Service (WiFi Dongle), Dedicated Short-Range Communications (DSRC) or any other wireless communication network. The remote computer system 79 may be under the control of the owner or manufacturer of the work machine system 10.

The tractor and/or trailer control systems 80, 90 may each comprise a tractor and/or trailer control communication module 87, 97 for transferring control signals between the tractor and/or trailer control system(s) 80, 90. The tractor and/or trailer control communication modules 87, 97 may be the same as the tractor and/or trailer external communication system 86, 96 and may be configured for wirelessly transferring control signals between the tractor and/or trailer control systems 80, 90. Alternatively, the tractor and/or trailer control communication modules 87, 97 may comprise connectable interfaces for a wired connection between the tractor and/or trailer control systems 80, 90 and may be configured to be connected during the connection of the tractor-trailer services connection 67. In particular, the tractor and/or trailer control communication modules 87, 97 may be or comprise the control ports 70, 73 of the tractor and trailer services connections 65, 66 respectively.

The tractor control system 80 and/or tractor controller 81 may be connected to and operable to control (a) the tractor drive system 18 and/or tractor braking system 28 to control the speed of the work machine 13, (b) the tractor electrical power system 38 and/or tractor fluid system 60, (c) the steering system 42 to control the steering and direction of travel of the work machine 13, (d) the tractor-trailer coupling 25, such as by actuation of the fastener 50, to control coupling of the tractor and trailer units 11, 12 and/or (e) tractor-trailer services connection 67, such as by actuation of the at least one services actuator 74, to control the coupling of the tractor and trailer drive systems 18, 19, tractor and trailer control systems 80, 90 and/or tractor and trailer fluid systems 60, 61.

The tractor control system 80 may be directly connected to (i.e. rather than via the tractor control communication module 87 and/or external communication system 86) and operable to control (c) to (e) if the actuators of the steering system 42, tractor-trailer coupling 25 and/or tractor-trailer services connection 67 are mounted to the tractor unit 11.

The trailer control system 90 and/or controller 91 may be connected to and operable to control (f) the trailer braking system 29 and/or if present the trailer drive system 19 to control the speed of the work machine 13, (g) the trailer electrical power system 39 and/or trailer fluid system 61, and/or (h) the haul body or tool 14 for performing work functions. The trailer control system 90 may be directly connected to (i.e. rather than via the trailer control communication module 97 and/or external communication system 96) and operable to control (c) to (e) if the actuators of the steering system 42, tractor-trailer coupling 25 and/or tractor-trailer services connection 67 are mounted to the trailer unit 12.

The tractor and/or trailer control systems 80, 90 may be configured to control (a) to (h) based upon inputs from the operator to the tractor and/or trailer operator input 85, 95 and/or via a control strategy, which may be implemented by the tractor and/or trailer processing units 83, 93 implementing instructions stored on the tractor and/or trailer memories 82, 92 and/or received from the remote computer system 79.

By virtue of the connection between the tractor and trailer control systems 80, 90, such as via the tractor and/or trailer control communication modules 87, 97, control signals may also be exchanged between the tractor and trailer units 11, 12. Therefore, when the tractor and trailer units 11, 12 are coupled together, the tractor control system 80 may be configured to control (f) to (h) and/or the trailer control system 90 may be configured to control (a) to (c). Therefore, the tractor unit 11 may be operable to control (f) to (h) on a plurality of trailer units 12 when the tractor unit 11 is coupled to each of the trailer units 12.

The tractor control system 80 may in particular be configured to control the tractor and trailer drive systems 18, 19 and the tractor and trailer braking systems 28, 29 (the latter optionally via the trailer control system 90) simultaneously so as to control the drive, braking and/or traction across the work machine 13. The tractor control system 80 may in particular be configured to control any of the parts of the trailer unit 12, such as the trailer control system 90, the trailer electrical power system 39, trailer fluid system 61, the haul body or tool 14 and/or the like. Hence the tractor and trailer unit 11, 12 may form a fully integrated and controlled work machine 13.

### INDUSTRIAL APPLICABILITY

The method of operating the work machine system 10 therefore comprises coupling and uncoupling different trailer units 12 from the tractor unit 11 to form different types of work machines 13. In particular, a first work machine 13 comprising the tractor unit 11 coupled to a first trailer unit 12 may be operated to perform a first work function. The tractor unit 11 may be uncoupled from the first trailer unit 12 by uncoupling the tractor coupling 20 from the trailer coupling 31 of the first trailer unit 12. The tractor unit 11 may be aligned with a second trailer unit 12. The tractor unit 11 may be coupled to the second trailer unit 12 by coupling the tractor coupling 20 with the trailer coupling 31 of the second trailer unit 12, thereby forming a second work machine 13. The second work machine 13 may then be operated to perform a second work function different to the first work function.

The tractor unit 11 may be coupled to further trailer units 12 to form further, different work machines 13 with different work functions.

A method of coupling the tractor-trailer coupling 25 may initially comprise bringing the tractor and trailer couplings 20, 31 into alignment with one another (FIG. 4). Subsequently the tractor and trailer couplings 20, 31 may be brought together such that the first and second load bearing portions 52, 53 contact and are mounted to one another (FIG. 5). The tractor and trailer couplings 20, 31 may be fastened together by engaging the fastener 50 with the at least one mount body 51. In particular, the at least one hook 50 may be actuated to hook around the at least one mount body 51 so as to couple the tractor-trailer coupling 25 (FIG. 6). During operation, the first and second load bearing portions 52, 53 may transfer the load between the tractor and trailer units 11, 12 whilst the at least one hook 50 may keep the tractor and trailer couplings 20, 31 coupled together.

A method of connection of the tractor-trailer services connection 67 is illustrated in FIGS. 7 and 8. Once the tractor-trailer coupling 25 is coupled such that the tractor and trailer units 11, 12 are mechanically coupled together, which may be in accordance with the method set out above, the tractor and trailer services connections 65, 66 may be aligned with one another, as shown in FIG. 7. Hence no separate alignment of the tractor and trailer services connections 65, 66 is required; instead the tractor-trailer coupling 25 achieves it. Subsequently, once aligned, the at least one services actuator 74 moves the tractor and/or trailer services connection 65, 66 relative to one another so as to connect them together as in FIG. 8. Electrical power, hydraulic power and/or control signals can therefore be exchanged between the tractor and trailer units 11, 12.

1. A work machine system comprising:
a tractor unit comprising a tractor coupling and at least one tractor ground engager driven by a tractor power system; and
a plurality of interchangeable trailer units, each trailer unit comprising at least one trailer ground engager and a trailer coupling, wherein:
the tractor coupling is releasably coupleable to the trailer coupling of each trailer unit for coupling the tractor unit to each trailer unit to form a work machine; and
the tractor and/or trailer units comprise a steering system for controlling pivoting about the articulation joint for steering the work machine.

2. The work machine system as claimed in claim 1 wherein:
different work machines with different work functions are formed when different trailer units are coupled to the tractor unit;
the tractor unit is not independently moveable about the ground by the tractor power system when the tractor unit is not coupled to a trailer unit;
the centre of mass of the tractor unit is offset from the at least one tractor ground engager such that the tractor unit is unbalanced when not coupled to a trailer unit; and/or the at least one tractor ground engager comprises a pair of wheels driven about a tractor rotational axis, wherein the tractor unit comprises no further tractor ground engagers in contact with the ground when the work machine is driven across the ground.

3. The work machine system as claimed in claim 1 wherein, at least one of the trailer units comprises a trailer power system for driving the at least one trailer ground engager, optionally wherein the at least one trailer unit with a trailer power system is not independently moveable about the ground by the trailer power system when the tractor unit is not coupled to the at least one trailer unit.

4. The work machine system as claimed in claim 1 wherein, the tractor and/or trailer units comprise an oscillation hitch for enabling oscillation of the tractor and trailer units relative to one another when the tractor and trailer couplings are coupled.

5. The work machine system as claimed in claim 1 wherein, the tractor unit comprises:
a tractor frame to which the at least one tractor ground engager, tractor power system and articulation joint are mounted;
the tractor coupling mounted to the articulation joint; and
the steering system extending across the articulation joint.

6. The work machine system as claimed in claim 1 wherein, the trailer unit comprises:
a trailer frame to which the at least one trailer ground engager and articulation joint are mounted;
the trailer coupling mounted to the articulation joint; and
the steering system extending across the articulation joint.

7. The work machine system as claimed in claim 1 wherein, the tractor and trailer couplings together form a tractor-trailer coupling of the work machine for mechanically connecting the tractor and trailer units together.

8. The work machine system as claimed in claim 1 wherein, the tractor unit comprises a tractor services connection, each trailer unit comprises a trailer services connection and the tractor services connection is coupleable to each trailer services connection for the transfer of electrical power, fluid and/or control signals between the tractor and trailer units.

9. The work machine system as claimed in claim 7 wherein, the coupling of the tractor-trailer coupling brings the tractor and trailer services connections into alignment with one another for connection together.

10. The work machine system as claimed in claim 7 wherein, the tractor-trailer coupling comprises at least one hook for hooking around at least one mount body so as to hold the tractor and trailer couplings together and/or comprises first and second load bearing portions configured to contact one another to transfer the mechanical load through the tractor-trailer coupling between the tractor and trailer units.

11. A tractor unit for a work machine system, the tractor unit comprising:
a tractor coupling for releasably coupling to a trailer coupling of a plurality of interchangeable trailer units;
at least one tractor ground engager driven by a tractor power system;
a tractor frame to which the tractor coupling, at least one tractor ground engager and tractor power system are mounted;
an articulation joint mounted to the tractor frame, to which the tractor coupling is mounted and about which the tractor coupling is configured to pivot relative to the tractor frame; and
a steering system for controlling the pivoting of the trailer coupling relative to the tractor frame for, when the tractor unit is coupled to a trailer unit, steering the tractor unit relative to the trailer unit about the articulation joint.

12. A plurality of trailer units for a work machine system, wherein, each trailer unit comprises:
a different at least one haul body or tool to the other trailer units for performing different work functions;
at least one ground engager for supporting the trailer unit on the ground;
a trailer coupling, the trailer couplings of the trailer units being configured for independently releasably coupling to a tractor coupling of a tractor unit to form a work machine.

13. A method of operating a work machine system, the work machine system comprising:
a tractor unit releasably coupleable to a trailer unit of a plurality of interchangeable trailer units to form a work machine; and
a steering system for steering the work machine by pivoting at least part of the tractor unit relative to at least part of the trailer unit about an articulation joint,
wherein the method comprises:
operating a first work machine comprising a tractor unit coupled to a first trailer unit to perform a first work function, the tractor unit comprising at least one tractor ground engager driven by a tractor power system;
uncoupling the tractor unit from the first trailer unit by uncoupling a tractor coupling of the tractor unit from a trailer coupling of the first trailer unit;
aligning the tractor unit with a second trailer unit;
coupling the tractor unit to the second trailer unit by coupling the tractor coupling with a trailer coupling of the second trailer unit, thereby forming a second work machine; and
operating the second work machine to perform a second work function different to the first work function.

14. The method as claimed in claim 13 wherein, coupling the tractor unit to the second trailer unit comprises bringing the tractor and trailer couplings together such that first and second load bearing portions thereof contact and are mounted to one another and subsequently fastening the tractor and trailer couplings together by engaging a fastener with at least one mount body.

15. The method as claimed in claim 13 further comprising:
uncoupling a tractor services connection from a trailer services connection of the first trailer unit;
by coupling the tractor coupling with the trailer coupling of the second trailer unit, aligning the tractor services connection with a trailer services connection of the second trailer unit; and
subsequently coupling the tractor services connection with the trailer services connection of the second trailer unit such that electrical power, fluid and/or control signals can be exchanged between the tractor and trailer units.
